(19) United States
(12) Patent Application Publication
(10) Pub. No.: US 2007/0241695 A1
(43) Pub. Date: Oct. 18, 2007

(54) POWER SUPPLY SYSTEM FOR DRIVING LAMPS

(75) Inventor: Shih-Hsien Chang, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc., Taoyuan Hsien (TW)

(21) Appl. No.: 11/467,378

(22) Filed: Aug. 25, 2006

(30) Foreign Application Priority Data
Apr. 17, 2006 (TW) 095113701

(51) Int. Cl. H05B 39/00

(52) U.S. Cl. 315/312

(57) ABSTRACT

A power supply system is used for driving the lamps. The power supply system includes an inverter, a transformer and a resonant circuit. The inverter is electrically connected to a DC power source for converting a DC voltage into an AC voltage. The transformer includes a primary winding coil and a secondary winding coil. The primary winding coil is electrically connected to the inverter for receiving the AC voltage, so that the output voltage of the secondary winding coil is boosted. The resonant circuit is electrically connected to the secondary winding coil and includes a plurality of high voltage-resistant capacitors. The high voltage-resistant capacitors are coupled to both terminals of the secondary winding coil. The leakage inductance of the transformer and the high voltage-resistant capacitors of the resonant circuit cooperatively result in a resonant effect, thereby generating a sinusoidal alternating voltage to drive the lamps.

### FIELD OF THE INVENTION

The present invention relates to a power supply system for driving lamps, and more particularly to a power supply system for driving lamps without the need of using any winding frame or shielding element to insulate the primary winding coil from the secondary winding coil of the transformer.

### BACKGROUND OF THE INVENTION

With increasing development of electronic industries, the general trends in designing thin and/or flat display panels are perceptible. Originally, the thin and flat display panels are applied to small-sized or medium-sized portable electronic devices. Recently, the applications of the thin and flat display panels can be extended to very large-scale video applications to replace the conventional CRT displays.

As known, the backlight module is a crucial component for driving light source in a flat display panel (FDP). Generally, the backlight module comprises a plurality of lamps and a power supply system for driving these lamps. By means of the power supply system, an input DC voltage is converted into an AC voltage, which is sufficient to drive these lamps. The performance of the power supply system will influence the stability of the lamps as well as the display quality of the flat display panel.

Referring to FIG. 1, a schematic circuit block diagram of a conventional power supply system for driving lamps is illustrated. As shown in FIG. 1, a DC voltage supplied from a DC power source 11 is transmitted to the power supply system 10 and converted into an AC voltage to drive and start a plurality of lamps 12. The power supply system 10 principally comprises an inverter 101, a transformer 102, a resonant circuit 103 and a plurality of impedance matching elements 104. The inverter 101 is electrically connected to the DC power source 11. Typically, the inverter 101 is consisted of several transistors (not shown) controlled by a pulse width modulation (PWM) controller (not shown). By the inverter 101, the DC voltage supplied from the DC power source 11 is converted into a high frequency AC voltage. The primary winding coil 1021 of the transformer 102 is electrically connected to the inverter 101 for receiving the high frequency AC voltage outputted from the inverter 101. The output voltage of the secondary winding coil 1022 of the transformer 102 is boosted, for example, from 200 volts to 1100˜2000 volts. The resonant circuit 103 is electrically connected to the secondary winding coil 1022 of the transformer 102 and receives the boosted output voltage from the transformer 102. Due to a resonant effect between the transformer 102 and the resonant circuit 103, a sinusoidal alternating voltage with frequency close to the resonant frequency is applied on the impedance matching elements 104 such as capacitors so as to drive the lamps 12.

Since the power supply system 10 converts the input DC voltage into the boosted AD voltage to drive the lamps, there is a large voltage difference between the primary winding coil 1021 and the secondary winding coil 1022 of the transformer 102. In other words, it is necessary to enhance electrical insulation between the primary winding coil 1021 and the secondary winding coil 1022. A conventional approach for enhancing electrical insulation and avoiding short-circuit breakdown increases the distance between the primary winding coil 1021 and the secondary winding coil 1022 by using winding frames and/or shielding elements. Nowadays, as the requirement of driving the lamps at high voltage is increased, the overall volume of the transformer is increased because the winding frames or shielding elements are indispensable. As a consequence, the bulky transformer increases the fabrication cost and is adverse to minimization slimness of the power supply system or the whole product. Moreover, the winding frames or shielding elements may fail to achieve the insulating object if the voltage difference between the primary winding coil 1021 and the secondary winding coil 1022 is too large.

In views of the above-described disadvantages resulted from the conventional method, the applicant keeps on carving unflaggingly to develop a power supply system for driving lamps according to the present invention through wholehearted experience and research.

### SUMMARY OF THE INVENTION

It is an object of the present invention to provide a power supply system for driving lamps without the need of using any winding frame or shielding element to insulate the primary winding coil from the secondary winding coil of the transformer, so that the power supply system or the flat display panel can be made slim or small-sized in a cost-effective manner.

In accordance with an aspect of the present invention, there is provided a power supply system arranged between a DC power source and a plurality of lamps for driving the lamps. The power supply system comprises an inverter, a transformer and a resonant circuit. The inverter is electrically connected to the DC power source for converting a DC voltage supplied from the DC power source into an AC voltage. The transformer includes a primary winding coil and a secondary winding coil. The primary winding coil is electrically connected to the inverter for receiving the AC voltage, so that the output voltage of the secondary winding coil is boosted. The resonant circuit is electrically connected to the secondary winding coil of the transformer and comprises a plurality of high voltage-resistant capacitors. The high voltage-resistant capacitors are coupled to both terminals of the secondary winding coil of the transformer. The leakage inductance of the transformer and the high voltage-resistant capacitors of the resonant circuit cooperatively result in a resonant effect, thereby generating a sinusoidal alternating voltage to drive the lamps.

In accordance with another aspect of the present invention, there is provided a power supply system arranged between a DC power source and a plurality of lamps for driving the lamps. The power supply system comprises an inverter, a transformer and a resonant circuit. The inverter is electrically connected to the DC power source for converting a DC voltage supplied from the DC power source into an AC voltage, wherein the inverter includes a plurality of high voltage-resistant capacitors. The transformer includes a primary winding coil and a secondary winding coil. Both terminals of the primary winding coil are coupled to the high voltage-resistant capacitors of the inverter. The AC voltage is received by the primary winding coil such that the output voltage of the secondary winding coil is boosted. The resonant circuit is electrically connected to the secondary winding coil of the transformer. The leakage inductance of the transformer and the resonant circuit cooperatively result in a resonant effect, thereby generating a sinusoidal alternating voltage to drive the lamps.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram of a conventional power supply system for driving lamps;

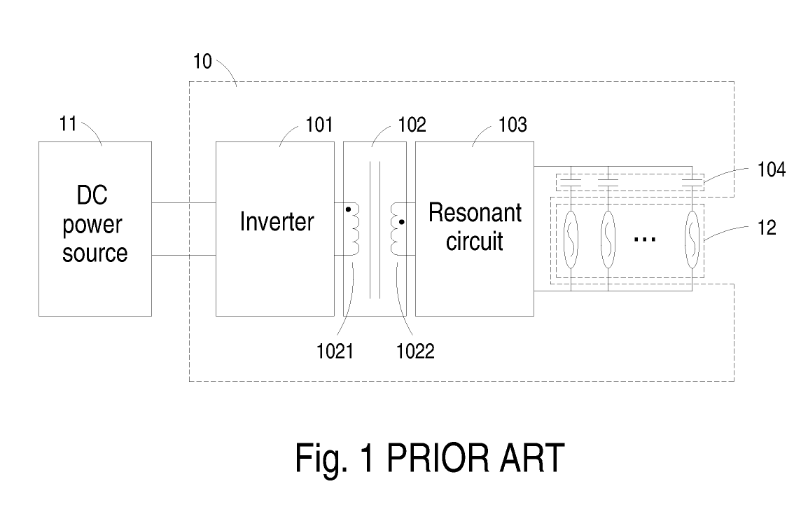

FIG. 2 is a schematic circuit block diagram of a power supply system for driving lamps according to a preferred embodiment of the present invention;

FIG. 3(a) is a schematic circuit block diagram illustrating another embodiment of the resonant circuit as shown in FIG. 2;

FIG. 3(b) is a schematic circuit block diagram illustrating a further embodiment of the resonant circuit as shown in FIG. 2; and

FIG. 4 is a schematic circuit block diagram of a power supply system for driving lamps according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

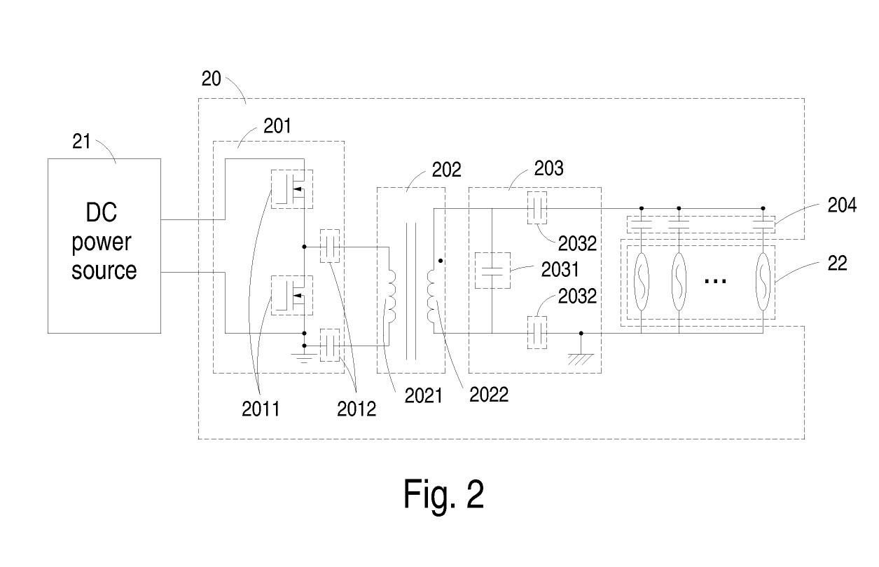

Referring to FIG. 2, a schematic circuit block diagram of a power supply system for driving lamps according to a preferred embodiment of the present invention is illustrated. As shown in FIG. 2, a DC voltage supplied from a DC power source 21 is transmitted to the power supply system 20 and converted into an AC voltage to drive and start a plurality of lamps 22. In this embodiment, the lamps 22 are cold-cathode fluorescent lamps (CCFL). The power supply system 20 principally comprises an inverter 201, a transformer 202, a resonant circuit 203 and a plurality of impedance matching elements 204. The inverter 201 is electrically connected to the DC power source 21. By the inverter 201, the DC voltage supplied from the DC power source 21 is converted into a high frequency AC voltage, which is transmitted to the primary winding coil 2021 of the transformer 202.

An exemplary inverter 201 is a full-bridge inverter or a half-bridge inverter, and comprises several switch elements 2011 such as transistors and several capacitors 2012. The inverter 201 shown in FIG. 2 is a half-bridge inverter, which is controlled by a pulse width modulation (PWM) controller (not shown). By switching the switch elements 2011 between switching-on and switching-off states, the DC voltage is converted into a high frequency AC voltage.

Please refer to FIG. 2 again. The primary winding coil 2021 of the transformer 202 is electrically connected to the inverter 201 for receiving the high frequency AC voltage outputted from the inverter 201. The output voltage of the secondary winding coil 2022 of the transformer 202 is boosted, for example, from 200 volts to 1100˜2000 volts. The both terminals of the primary winding coil 2021 of the transformer 202 are connected to the first ends of the capacitors 2012. The second ends of the capacitors 2012 is connected to the switch elements 2011.

The resonant circuit 203 comprises a first capacitor 2031 and several high voltage-resistant capacitors 2032. The resonant circuit 203 is electrically connected to the secondary winding coil 2022 of the transformer 202 and receives the boosted output voltage from the transformer 202. Since the leakage inductance of the transformer 202 and first capacitor 2031 and the high voltage-resistant capacitors 2032 of the resonant circuit 203 cooperatively result in a resonant effect, a sinusoidal alternating voltage with frequency close to the resonant frequency is applied on the impedance matching elements 204 such as capacitors so as to drive the lamps 22. The impedance matching elements 204 are interconnected between the resonant circuit 203 and the lamps 22 for protecting the lamps 22 and stabilizing the current flowing through the lamps 22, thereby emitting stable light.

In the above embodiments, the high voltage-resistant capacitors 2032 are Y-capacitors because the rated voltage thereof (e.g. greater than 1000 volts) is relatively larger than the conventional capacitors. The other electrical properties of the Y-capacitors are known in the art, and are not redundantly described herein. As previously described, winding frames and/or shielding elements are used to separate the primary winding coil and the secondary winding coil of the transformer according to prior art. The conventional approach increases the fabrication cost and is adverse to minimization slimness of the power supply system or the whole product. In contrast, according to the present invention, since the high voltage-resistant capacitors 2032 coupled to the both terminals of the secondary winding coil 2022 of the transformer 202 may withstand high voltage, the electrical insulation between the primary winding coil 2021 and the secondary winding coil 2022 is enhanced.

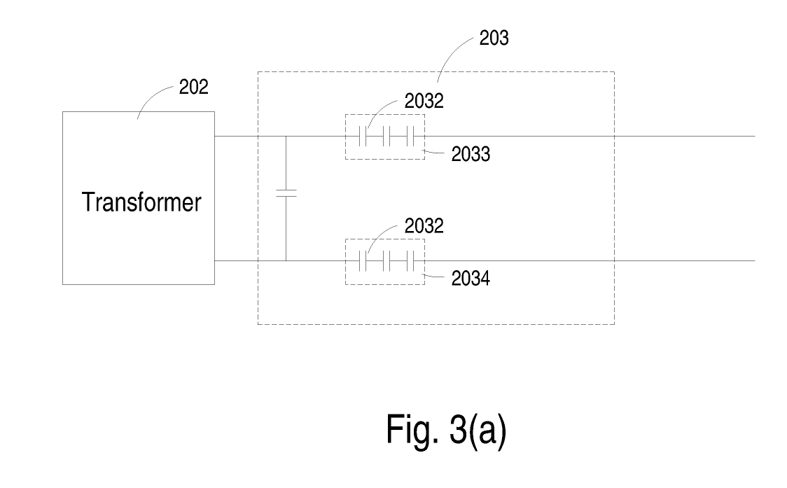

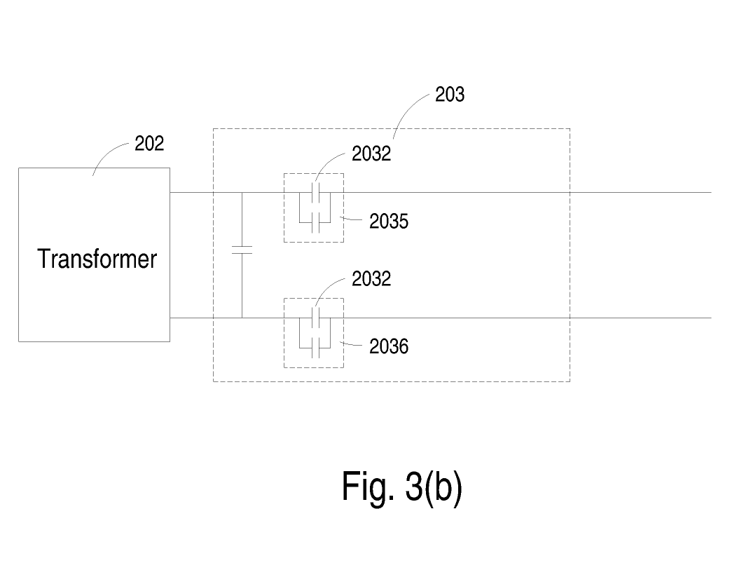

For increasing the ability to withstand higher voltage, these two high voltage-resistant capacitors 2032 as shown in FIG. 2 may be replaced by a first high voltage-resistant capacitor set 2033 and a second high voltage-resistant capacitor set 2034, as is shown in FIG. 3(a). Each of the first set 2033 and the second set 2034 includes a plurality of high voltage-resistant capacitors 2032 connected in series. Alternatively, these two high voltage-resistant capacitors 2032 as shown in FIG. 2 may be replaced by a first high voltage-resistant capacitor set 2035 and a second high voltage-resistant capacitor set 2035, as is shown in FIG. 3(b). Each of the first set 2035 and the second set 2036 includes a plurality of high voltage-resistant capacitors 2032 connected in parallel.

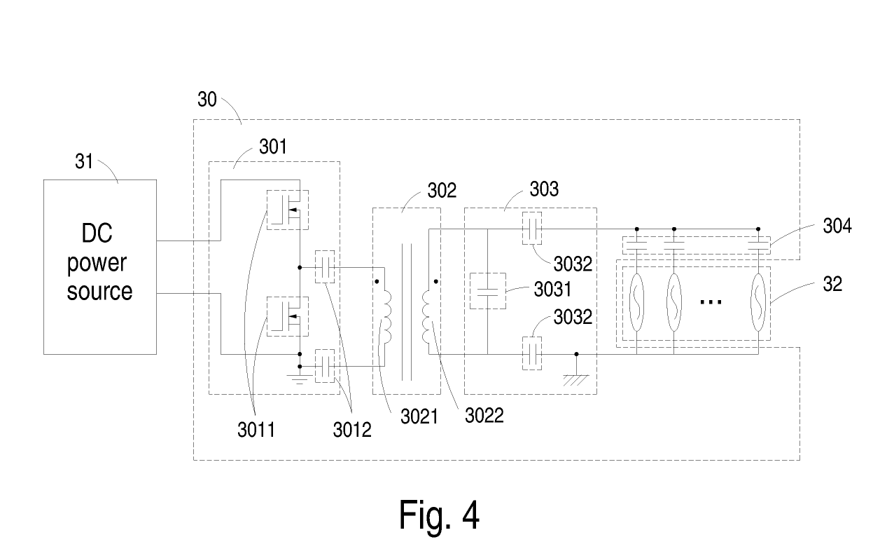

Referring to FIG. 4, a schematic circuit block diagram of a power supply system for driving lamps according to another preferred embodiment of the present invention is illustrated. As shown in FIG. 4, a DC voltage supplied from a DC power source 31 is transmitted to the power supply system 30 and converted into an AC voltage to drive and start a plurality of lamps 32. The power supply system 30 principally comprises an inverter 301, a transformer 302, a resonant circuit 303 and a plurality of impedance matching elements 304. The inverter 301 is electrically connected to the DC power source 31. By the inverter 301, the DC voltage supplied from the DC power source 31 is converted into a high frequency AC voltage, which is transmitted to the primary winding coil 3021 of the transformer 302.

An exemplary inverter 301 is a full-bridge inverter or a half-bridge inverter, and comprises several switch elements 3011 such as transistors and several high voltage-resistant capacitors 3012. The inverter 301 shown in FIG. 4 is a half-bridge inverter, which is controlled by a pulse width modulation (PWM) controller (not shown). By switching the switch elements 3011 between switching-on and switching-off states, the DC voltage is converted into a high frequency AC voltage. The high voltage-resistant capacitors 3012 are coupled to both terminals of the primary winding coil 3021 of the transformer 302 and the switch elements 3011. In some embodiments, the high voltage-resistant capacitors 3012 are Y-capacitors because the rated voltage thereof (e.g. greater than 1000 volts) is relatively larger than the conventional capacitors. The other electrical properties of the Y-capacitors are known in the art, and are not redundantly described herein. As previously described, winding frames and/or shielding elements are used to separate the primary winding coil and the secondary winding coil of the transformer according to prior art. The conventional approach increases the fabrication cost and is adverse to minimization slimness of the power supply system or the whole product. In contrast, according to the present invention, since the high voltage-resistant capacitors 3012 coupled to the both terminals of the primary winding coil 3021 of the transformer 302 may withstand high voltage, the electrical insulation between the primary winding coil 3021 and the secondary winding coil 3022 is enhanced.

Please refer to FIG. 4 again. The primary winding coil 3021 of the transformer 302 is electrically connected to the inverter 301 for receiving the high frequency AC voltage outputted from the inverter 201. The output voltage of the secondary winding coil 3022 of the transformer 302 is boosted, for example, from 200 volts to 1100˜2000 volts.

The resonant circuit 303 comprises a first capacitor 3031 and several capacitors 3032. The resonant circuit 303 is electrically connected to the secondary winding coil 3022 of the transformer 302 and receives the boosted output voltage from the transformer 302. Since the leakage inductance of the transformer 302 and first capacitor 3031 and the second capacitors 3032 of the resonant circuit 303 cooperatively result in a resonant effect, a sinusoidal alternating voltage with frequency close to the resonant frequency is applied on the impedance matching elements 304 such as capacitors so as to drive the lamps 32.

From the above description, by utilizing high voltage-resistant capacitors to withstand high voltage difference between the primary winding coil and the secondary winding coil of the transformer, the electrical insulation is enhanced. Since the winding frames and/or shielding elements are exempted, the power supply system or the flat display panel can be made slim or small-sized in a cost-effective manner.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply system arranged between a DC power source and a plurality of lamps for driving said lamps, said power supply system comprising:
an inverter electrically connected to said DC power source for converting a DC voltage supplied from said DC power source into an AC voltage;
a transformer including a primary winding coil and a secondary winding coil, wherein said primary winding coil is electrically connected to said inverter for receiving said AC voltage, so that the output voltage of said secondary winding coil is boosted; and
a resonant circuit electrically connected to said secondary winding coil of said transformer and comprising a plurality of high voltage-resistant capacitors, wherein said high voltage-resistant capacitors are coupled to both terminals of said secondary winding coil of said transformer, and the leakage inductance of said transformer and said high voltage-resistant capacitors of said resonant circuit cooperatively result in a resonant effect, thereby generating a sinusoidal alternating voltage to drive said lamps.

2. The power supply system according to claim 1 further comprising a plurality of impedance matching elements electrically connected between said resonant circuit and said lamps for stabilizing the current flowing through said lamps.

3. The power supply system according to claim 1 wherein said inverter is a full-bridge inverter or a half-bridge inverter.

4. The power supply system according to claim 3 wherein said inverter includes several switch elements.

5. The power supply system according to claim 4 wherein said switch elements are transistors.

6. The power supply system according to claim 4 wherein said inverter further comprises a plurality of capacitors coupled between said switch elements and both terminals of said primary winding coil of said transformer.

7. The power supply system according to claim 1 wherein said resonant circuit further comprises a first capacitor.

8. The power supply system according to claim 1 wherein said high voltage-resistant capacitors are Y-capacitors.

9. The power supply system according to claim 1 wherein said high voltage-resistant capacitors are divided into a first high voltage-resistant capacitor set and a second high voltage-resistant capacitor set, which respectively includes a first number and a second number of high voltage-resistant capacitors connected in series.

10. The power supply system according to claim 1 wherein said high voltage-resistant capacitors are divided into a first high voltage-resistant capacitor set and a second high voltage-resistant capacitor set, which respectively includes a first number and a second number of high voltage-resistant capacitors connected in parallel.

11. The power supply system according to claim 1 wherein said lamps are cold-cathode fluorescent lamps.

12. A power supply system arranged between a DC power source and a plurality of lamps for driving said lamps, said power supply system comprising:
an inverter electrically connected to said DC power source for converting a DC voltage supplied from said DC power source into an AC voltage, wherein said inverter includes a plurality of high voltage-resistant capacitors;
a transformer including a primary winding coil and a secondary winding coil, wherein both terminals of said primary winding coil are coupled to said high voltage-resistant capacitors of said inverter, and said AC voltage is received by said primary winding coil such that the output voltage of said secondary winding coil is boosted; and
a resonant circuit electrically connected to said secondary winding coil of said transformer, wherein the leakage inductance of said transformer and said resonant circuit cooperatively result in a resonant effect, thereby generating a sinusoidal alternating voltage to drive said lamps.

13. The power supply system according to claim 12 further comprising a plurality of impedance matching elements electrically connected between said resonant circuit and said lamps for stabilizing the current flowing through said lamps.

14. The power supply system according to claim 12 wherein said inverter is a full-bridge inverter or a half-bridge inverter.

15. The power supply system according to claim 14 wherein said inverter further includes several switch elements.

16. The power supply system according to claim 15 wherein said switch elements are transistors.

17. The power supply system according to claim 15 wherein said high voltage-resistant capacitors of said inverter are coupled between said switch elements and both terminals of said primary winding coil of said transformer.

18. The power supply system according to claim 12 wherein said resonant circuit further comprises a first capacitor and a second capacitor.

19. The power supply system according to claim 12 wherein said high voltage-resistant capacitors are Y-capacitors.

20. The power supply system according to claim 12 wherein said lamps are cold-cathode fluorescent lamps.
